(19) United States
(12) Patent Application Publication
(10) Pub. No.: US 2018/0031375 A1
(43) Pub. Date: Feb. 1, 2018

(54) METHODS, APPARATUSES, AND MOBILE TERMINALS FOR POSITIONING AND SEARCHING FOR A VEHICLE

(71) Applicant: AutoChips Inc., Hefei City (CN)

(72) Inventor: ZHUOMING DENG, Hefei City (CN)

(21) Appl. No.: 15/351,433

(22) Filed: Nov. 14, 2016

(30) Foreign Application Priority Data
Aug. 1, 2016 (CN) 201610626638.5

(51) Int. Cl. G01C 21/20; G01C 15/00; G01C 21/36; G01C 21/34; G01C 21/30

(52) U.S. Cl. CPC G01C 21/20; G01C 21/206; G01C 21/3407; G01C 21/30; G01C 21/3623; G01C 15/002

(57) ABSTRACT

Methods, apparatuses, and mobile terminals for positioning and searching for a vehicle are disclosed. The method of positioning a location of a vehicle in a predetermined place may include: collecting surrounding environmental information of the vehicle; and determining the location of the vehicle in the predetermined place by comparing the surrounding environmental information with a previously acquired map of the predetermined place. Thereby, the position of the vehicle on the map can be determined in absence of GPS positioning, enabling pinpoint positioning and navigation of the vehicle.

### CROSS-REFERENCE TO RELATED APPLICATIONS

This application claims all benefits accruing under 35 U.S.C. §119 from China Patent Application No. 201610626638.5, filed on Aug. 1, 2016 in the China Intellectual Property Office, the contents of which are hereby incorporated by reference.

### TECHNICAL FIELD

Embodiments of the present disclosure generally relate to positioning technologies, and in particular relate to methods, apparatuses, and mobile terminals for positioning and searching for a vehicle.

### BACKGROUND

The Global Positioning System (GPS) is a global navigation satellite system that provides real-time location and time information in a global scale. Most vehicles (e.g., cars) or mobile terminals (e.g., phones, smart devices) today are typically equipped with a GPS system. GPS can provide functions including vehicle positioning, anti-theft, anti-robbery, driving route monitoring, and call command, etc. To achieve all the above functions three elements must be included including a GPS terminal, transmission network, and monitoring platform.

However, the transmission network is an uncertain factor that in the absence of wireless network coverage, or in places with a poor wireless network signal, a GPS signal cannot be received so that the positioning function may be unable to implement. For example, in some underground garages, because the GPS signal cannot be acquired, the position of the car in the garage cannot be determined and so it would be awkward to find the position where the car parks.

### SUMMARY

Embodiments of the present disclosure provide methods, apparatuses, and mobile terminals for positioning and searching for a vehicle, which can determine the position of the vehicle on the map in absence of GPS positioning, thus enabling pinpoint positioning and navigation of the vehicle.

There is provided a method of positioning a location of a vehicle parked in a predetermined place, the method comprising: collecting surrounding environmental information of the vehicle; determining the location of the vehicle in the predetermined place by comparing the surrounding environmental information with a map of the predetermined place that is acquired in advance.

The step of collecting the surrounding environmental information of the vehicle may comprise: emitting, by the vehicle, laser light in a predetermined direction; and receiving a reflected light signal by an obstacle reflecting the laser light.

It is difficult to receive a global positioning system (GPS) signal in the predetermined place.

The step of comparing the surrounding environmental information with the map of the predetermined place may comprise: analyzing the reflected light signal to obtain a driving route of the vehicle in the predetermined place; and determining the location of the vehicle in the predetermined place by comparing the driving route with the map of the predetermined place.

The step of analyzing the reflected light signal to obtain the driving route of the vehicle comprises: calculating a distance between the vehicle and the obstacle based on a time interval from emitting the laser light to receiving the reflected light signal; and computing and determining the driving route based on the distance, depth information and shapes of obstacles along the driving route of the vehicle.

Simultaneous Localization and Mapping (SLAM) positioning technology is applied to continuously collect the types of the obstacles along the determined driving route and the distances between the vehicle and the obstacles along the determined the driving route.

The step of determining the location of the vehicle by comparing the surrounding environmental information with the map of the predetermined place may comprise: analyzing the reflected light signal to obtain the surrounding environmental information of the vehicle; and so determining the location of the vehicle in the predetermined place by comparing the surrounding environmental information with the map of the predetermined place.

Simultaneous Localization and Mapping (SLAM) positioning technology is applied to continuously collect the types of the obstacles along the determined driving route and distances between the vehicle and the obstacles along the determined the driving route to obtain the surrounding information of the vehicle.

The method may further comprise using a binocular vision algorithm to obtain the surrounding environmental information of the vehicle.

There is also provided a method of searching for a vehicle parked in a predetermined place, the method being performed by a mobile terminal and comprising: obtaining a map of the predetermined place and a location of the vehicle, wherein the location of the vehicle may be obtained using the positioning method mentioned above; obtaining a current location of the mobile terminal on the map of the predetermined place; establishing a navigation path from the current location to the location of the vehicle; and searching for the vehicle according to the navigation path.

The block of obtaining the current location of the mobile terminal on the map of the predetermined place may comprise: obtaining identification information of the current location of the mobile terminal; and determining the current location of the mobile terminal on the map of the predetermined place based on the identification information.

The identification information may be a two-dimensional code.

There is also provided an apparatus for positioning a location of a vehicle in a predetermined place, the apparatus comprising: a collecting device configured to collect surrounding environmental information of the vehicle; a processor coupled to the collecting device and configured to determine the location of the vehicle in the predetermined place by comparing the surrounding environmental information with a map of the predetermined place that is acquired in advance.

The collecting device may comprise: at least one of laser emitter configured to emit laser light in a predetermined direction; and at least one of laser receiver configured to receive a reflected light signal by an obstacle reflecting the laser light.

It is difficult to receive a global positioning system (GPS) signal in the predetermined place.

The processor may be configured to analyze the reflected light signal to obtain a driving route of the vehicle in the predetermined place, and so determine the location of the vehicle in the predetermined place by comparing the driving route with the previously acquired map of the predetermined place.

The processor may be configured to analyze the reflected light signal to obtain the surrounding environmental information of the vehicle, and so determine the location of the vehicle in the predetermined place by comparing the surrounding environmental information with the map of the predetermined place.

The collecting device may comprise a visual sensor configured to use a binocular vision algorithm to obtain the surrounding environmental information of the vehicle.

There is also provided a mobile terminal for searching for a vehicle parked in a predetermined place, the mobile terminal comprising a non-transitory program storage medium and a processor, the non-transitory program storage medium comprising: an acquisition module configured to acquire a map of the predetermined place and a location of the vehicle in the predetermined place, wherein the location of the vehicle in the predetermined place may be determined by the positioning apparatus described above and may be received by the acquisition module from the vehicle; a positioning module configured to obtain a current location of the mobile terminal in the predetermined place; and a navigation module coupled to the collecting module and the positioning module respectively, and configured to establish a navigation path from the current location to the location of the vehicle and thus find the vehicle according to the navigation path.

The positioning module may comprise: an identification information acquisition unit configured to obtain identification information of the current location; and a parsing unit configured to determine the current location of the mobile terminal on the map of the predetermined place based on the identification information.

Advantages of the present disclosure may follow. According to the method of positioning a vehicle provided by the disclosure, the vehicle may collect its surrounding environmental information, which may then be compared with a previously acquired map of the predetermined place to determine the location of the vehicle in the predetermined place. Thus, the position of the vehicle on the map can be determined in absence of GPS positioning, enabling pinpoint positioning and navigation of the vehicle.

### BRIEF DESCRIPTION OF THE DRAWINGS

FIG. 1 is a flowchart illustrating a first embodiment of a method of positioning a vehicle according to the disclosure.

FIG. 2a is a schematic diagram showing a map of a predetermined place that is acquired in the first embodiment of the method of positioning a vehicle.

FIG. 2b is a schematic diagram showing surrounding environmental information that is acquired in the first embodiment of the method of positioning a vehicle.

FIG. 3 is a flowchart illustrating a second embodiment of a method of positioning a vehicle according to the disclosure.

FIG. 4 is a schematic diagram showing a driving route of the vehicle in the second embodiment of the method of positioning a vehicle.

FIG. 5 is a flowchart illustrating a third embodiment of a method of positioning a vehicle according to the disclosure.

FIG. 6 is a schematic diagram showing a map of a surrounding area of the vehicle in the third embodiment of the method of positioning a vehicle.

FIG. 7 is a block diagram illustrating a first embodiment of an apparatus for positioning a vehicle according to the disclosure.

FIG. 8 is a block diagram illustrating a collecting module 71 in the first embodiment of the apparatus for positioning a vehicle.

FIG. 9 is block diagram illustrating another structure of a collecting module 71 in the first embodiment of the apparatus for positioning a vehicle.

FIG. 10 is a block diagram illustrating a second embodiment of an apparatus for positioning a vehicle according to the disclosure.

FIG. 11 is a flowchart illustrating an embodiment of a method of searching for a vehicle according to the disclosure.

FIG. 12 is a flowchart illustrating a block S1102 in a method of searching for a vehicle according to the disclosure.

FIG. 13 is a block diagram illustrating an embodiment of a mobile terminal for searching for a vehicle according to the disclosure.

FIG. 14 is a block diagram illustrating a positioning module 132 in an embodiment of a mobile terminal according to the disclosure.

### DETAILED DESCRIPTION

For a thorough understanding of the present disclosure, numerous specific details are set forth in the following description for purposes of illustration but not of limitation, such as particularities of system structures, interfaces, techniques, et cetera. However, it should be appreciated by those of skill in the art that, in absence of these specific details, the present disclosure may also be carried out through other implementations. In other instances, a detailed description of well-known devices, circuits, and methods is omitted, so as to avoid unnecessary details from hindering the description of the disclosure.

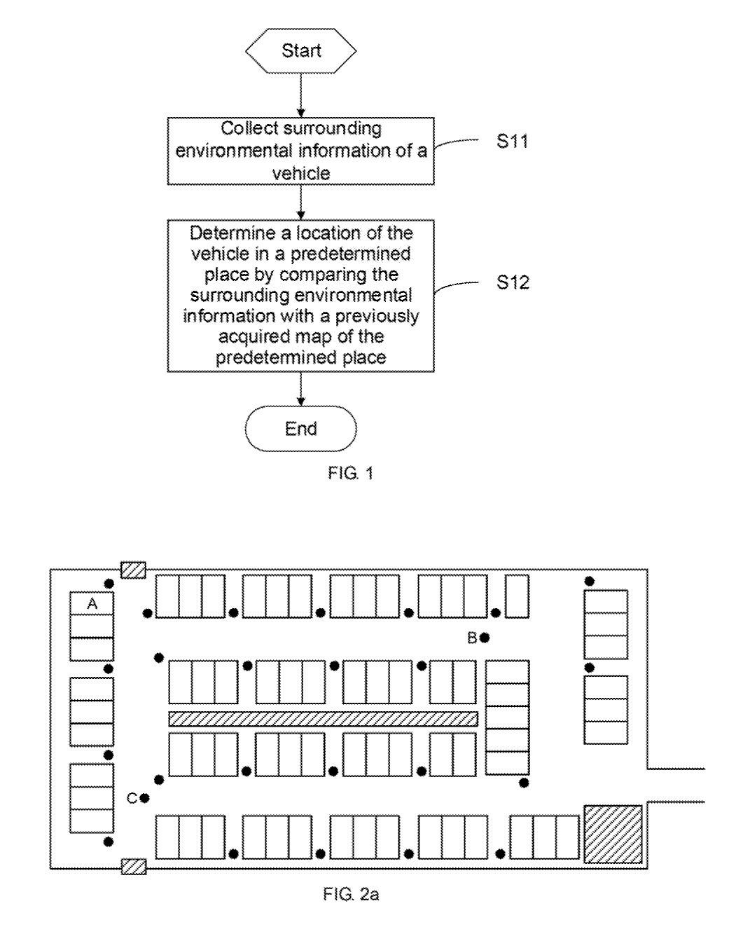

Referring to FIG. 1, a flowchart of a first embodiment of a method of positioning a vehicle according to the disclosure is depicted. For purposes of illustration, the method is illustrated as being sequential. However, portions of the method may be performed in other orders or in parallel (e.g., simultaneously). The method may be used to determine the location of the vehicle in a predetermined place. The vehicle may be, for example, a car, and the predetermined place may be a place where a GPS signal is difficult to reach, i.e., a place where the GPS signal is poor or no GPS signal is available. For example, the predetermined place may be an underground car park or garage where cars are typically parked. The method may comprise the following blocks.

At S11, the method includes collecting surrounding environmental information of the vehicle.

The surrounding environmental information of the vehicle may comprise information about obstacles, such as roads, walls, columns, barrier gates, and fences, as well as information about signages, fire-fighting equipment, lighting equipment, etc.

The surrounding environmental information of the vehicle may be collected by way of laser, camera, infrared detection, acoustic detection, and so on.

In particular, the photograph taken by a camera can be performed color or grayscale analysis to extract the environmental information from the photo. Alternatively, by counting the time for the emitted infrared light or sound waves to be reflected back, the depth information of the obstacle can be analyzed, to obtain a shape of the obstacle.

Optionally, a binocular vision algorithm may be used to collect the surrounding environmental information of the vehicle. The binocular vision algorithm is also referred to as binocular vision stereo matching algorithm, which primarily captures images of a target obstacle from two directions, and then employs a preset algorithm to obtain depth information of the target obstacle and so establishes a corresponding three-dimensional graphic, thus better acquiring the surrounding environmental information of the vehicle.

At S12, the method includes determining a location of the vehicle in the predetermined place by comparing the surrounding environmental information with a map of the predetermined place that is acquired in advance.

Optionally, the map of the predetermined place that is previously acquired may be downloaded by the vehicle from a map server over a network connection before the vehicle enters the predetermined place. For instance, when during the driving process the navigation destination is set as a certain parking lot, then the vehicle may begin to connect to the network and download the map of the parking lot, otherwise the map may be unable to download after the vehicle enters the parking lot, because the network may be disconnected.

Alternatively, the map of the predetermined place may be acquired through a local area network (LAN) such as a Wi-Fi or Bluetooth network set up by the predetermined place, before the vehicle enters the predetermined place. For example, when the vehicle stops at a gate of an underground garage before entering the garage, it may automatically connect to a Wi-Fi network set up by the garage and so obtain the map of the garage over the Wi-Fi network.

It can be appreciated that the map of the predetermined place that is previously acquired may be a map of obstacles, in which are information of drawn obstacles such as roads, walls, columns, barrier gates, fences, as well as graphics of signages, fire-fighting equipment, lighting equipment, and so on.

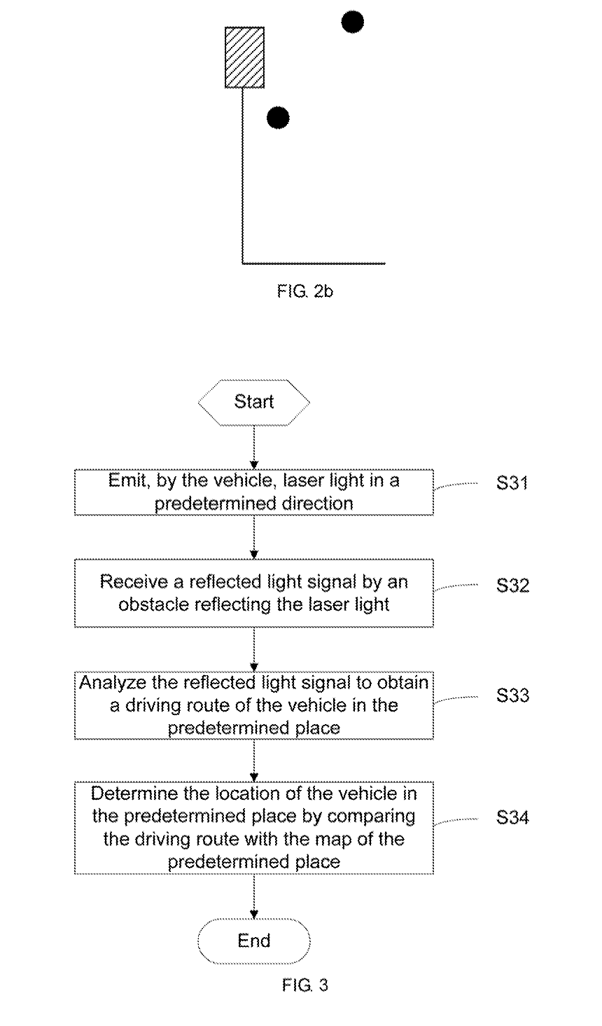

In a particular embodiment, as is shown in FIGS. 2a and 2b, where FIG. 2a shows a map of a predetermined place, and FIG. 2b depicts the collected surrounding environmental information of the vehicle that comprises a cavity in the vicinity (shown in a polyline) and two columns (shown in circles), so by comparing the surrounding environmental information with FIG. 2a, it can be determined that the parking location would be at position of A on the map.

According to the method of positioning a vehicle that is provided by the present embodiment, the vehicle may collect its surrounding environmental information, which may then be compared with a map of the predetermined place that is previously acquired to determine the location of the vehicle in the predetermined place. Therefore, the position of the vehicle on the map can be determined in absence of GPS positioning, enabling pinpoint positioning and navigation of the vehicle.

Referring now to FIG. 3, a flowchart illustrating a second embodiment of a method of positioning a vehicle according to the disclosure is depicted. For purposes of illustration, the method is illustrated as being sequential. However, portions of the method may be performed in other orders or in parallel (e.g., simultaneously). The method may comprise the following blocks.

At S31, the method includes emitting laser light in a predetermined direction (e.g., to the front of the vehicle).

At S32, the method includes receiving a reflected light signal by an obstacle reflecting the laser light.

Specifically, laser emitters and receivers may be installed at specified positions of the vehicle, where the number and positions of the laser emitters and receivers are not limited, namely an arbitrary number of laser emitters and receivers can be installed at arbitrary positions of the vehicle. For example, the laser emitters and receivers can be mounted in the middle of the front, middle of the rear, and on the top of the vehicle.

Optionally, the laser emitters may emit laser light in a directional manner, or emit laser light circularly in different directions, namely the laser emitters may rotate at a certain frequency and angular steps.

At S33, the method includes analyzing the reflected light signal to obtain a driving route of the vehicle in the predetermined place.

In particular, based on the time interval from emitting the laser light to receiving the reflected light signal, the distance between the vehicle and the obstacle can be calculated, and the depth information and shape of the obstacle may be computed further. For example, the distance may be calculated using the following equation:

$$L = \frac{s \times T}{2} ;$$

where L is the distance between the vehicle and the obstacle, s is the speed of light, and T is the time interval between emitting the laser light and receiving the reflected light signal.

In one embodiment, the simultaneous localization and mapping (SLAM) positioning technology, also known as concurrent mapping and localization (CIVIL), may be employed. The SLAM problem may be described as follows: a vehicle starts to move from an unknown location in an unknown environment, and conducts self-positioning based on an estimate of its location and a map of the environment during the moving process, and meanwhile constructs an incremental map on the basis of self-positioning, thus achieving self-positioning and navigation.

In a particular embodiment, laser light can be used to obtain the depth information of the surrounding environment and a coordinate system may be established, so that when the vehicle moves (e.g., when coordinates change), the SLAM technology may be used to continuously collect the types and distances of surrounding obstacles along the driving route of the vehicle, so the driving route of the vehicle can be thus determined.

Optionally, blocks S31, S32, and S33 can be repeatedly performed, that is, the laser light may be emitted in a preset direction of the vehicle with a certain frequency, and light signals reflected back from obstacles may be received accordingly. Consequently, by analyzing the reflected light signals in real time, combined with the vehicle's own speed, the driving route of the vehicle in the predetermined place can be obtained.

At S34, the method includes determining the location of the vehicle in the predetermined place by comparing the driving route with the map of the predetermined place.

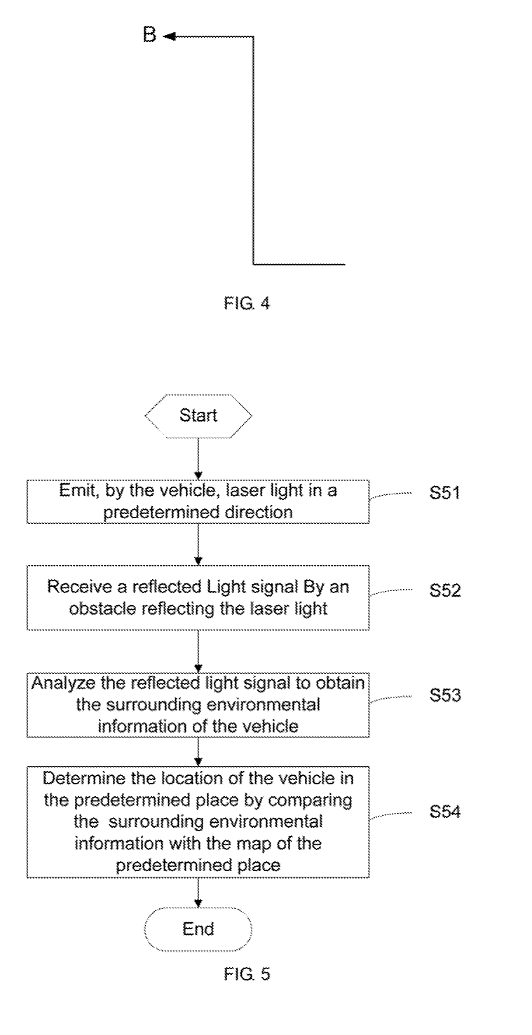

In connection with FIGS. 4 and 2a, in which an example of the driving route of the vehicle is shown in FIG. 4. In the given example, the driving route are compared against routes on the map for a match, and it is found that the end point of the driving route is the point B on the map, thus it is determined that the vehicle is at the point B of the predetermined place.

Referring now to FIG. 5, a flowchart illustrating a third embodiment of a method of positioning a vehicle according to the disclosure is depicted. For purposes of illustration, the method is illustrated as being sequential. However, portions of the method may be performed in other orders or in parallel (e.g., simultaneously). The method may comprise the following blocks.

At S51, the method includes emitting laser light in a predetermined direction of the vehicle.

At S52, the method includes receiving a reflected light signal by an obstacle reflecting the laser light.

Blocks S51 and S52 are similar to blocks S31 and S32 as described in the second embodiment, and thus will not be detailed again.

At S53, the method includes analyzing the reflected light signal to obtain the surrounding environmental information of the vehicle.

At S54, the method includes determining the location of the vehicle in the predetermined place by comparing the surrounding environmental information with the map of the predetermined place.

In particular, the laser light can be employed to acquire the depth information of the surrounding environment and a coordinate system may be established, the SLAM technology may be employed further to obtain the types and distances of the surrounding obstacles through scanning, graphics of which may then be depicted on the coordinate system. For example, when the vehicle moves (e.g., when coordinates change), the SLAM technology may be applied to continuously collect the types of the obstacles along the determined driving route and distances between the vehicle and the obstacles along the determined the driving route to obtain the surrounding information of the vehicle. Further, a whole map of the surrounding area along the driving route of the vehicle can be depicted.

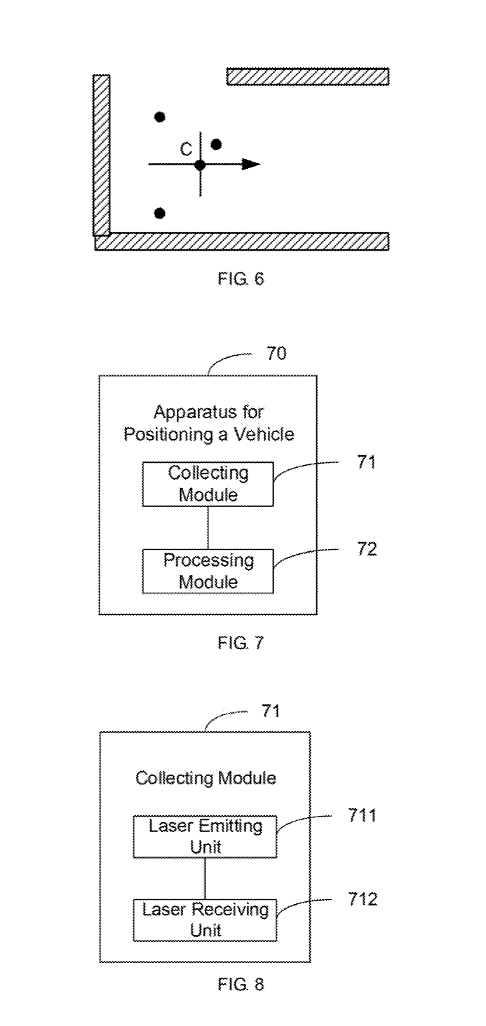

In connection with FIGS. 6 and 2a, in which an example of the map of the surrounding area of the vehicle is shown in FIG. 6. In the given example, the map of the surrounding area of the coordinates are compared with the map of the predetermined place for a match, and it is determined that the vehicle is at the point C of the predetermined place.

Optionally, after completion of the above three embodiments and when the vehicle stops, the location of the vehicle in the predetermined place can be transmitted to a mobile terminal. When the mobile terminal again enters the predetermined place to look for the vehicle, it would be able to find the vehicle according to the received location information of the vehicle and the map of the predetermined place, without needing a GPS signal.

Referring now to FIG. 7, a block diagram of a first embodiment of an apparatus for positioning a location of a vehicle in a predetermined place is depicted. Optionally, the apparatus 70 can be a vehicle-mounted positioning apparatus. The apparatus 70 may comprise a collecting module 71 configured to collect surrounding environmental information of the vehicle and a processing module 72 coupled to the collecting module 71 and configured to determine a location of the vehicle in the predetermined place by comparing the surrounding environmental information with a previously acquired map of the predetermined place.

The collecting module 71 may use an SLAM laser device, laser emitter and laser receiver, laser transceiver, or visual sensor to collect the surrounding environmental information. The processing module 72 can be implemented as a microprocessor or central processing unit (CPU) to determine the location of the vehicle. The predetermined place may be a place where a GPS signal is difficult to reach.

Optionally, in a particular embodiment, as shown in FIG. 8, the collecting module 71 may comprise a laser emitting unit 711 configured to emit laser light in a preset direction of the vehicle and a laser receiving unit 712 configured to receive a light signal reflected from an obstacle.

It can be appreciated that the laser emitting unit 711 and the laser receiving unit 712 may be implemented as one or more laser emitters and receivers, or as one or more laser transceivers with both the laser emitting and laser receiving functions.

Optionally, in one embodiment, the processing module 72 may be configured to analyze the reflected light signal to obtain a driving route of the vehicle in the predetermined place, and so determine the location of the vehicle in the predetermined place by comparing the driving route with the map of the predetermined place.

Optionally, in one embodiment, the processing module 72 may be configured to analyze the reflected light signal to draw a map of a surrounding area of the vehicle, and so determine the location of the vehicle in the predetermined place by comparing the map of the surrounding area with the map of the predetermined place.

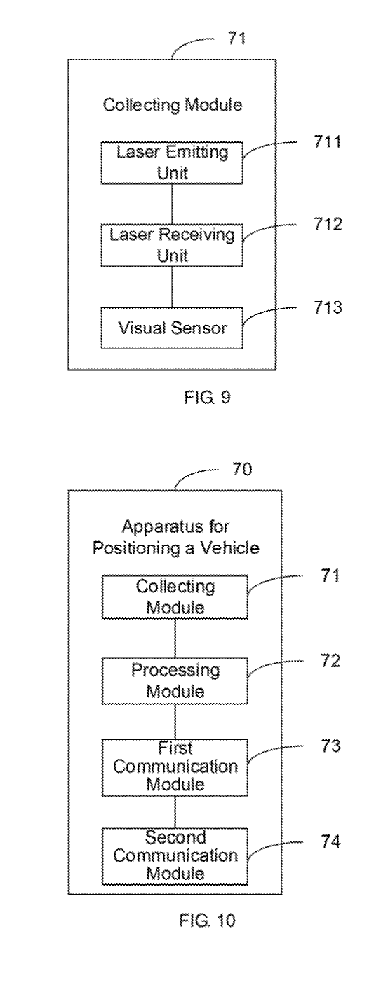

Optionally, in one embodiment, as shown in FIG. 9, the collecting module 71 may further comprise a visual sensor 713 configured to use a binocular vision algorithm to obtain the surrounding environmental information of the vehicle.

Optionally, as shown in FIG. 10, the apparatus 70 may further comprise a first communication module 73 coupled to the processing module 72 and configured to connect to a local area network (LAN) set up by the predetermined place and so acquire a map of the predetermined place, and a second communication module 74 coupled to the processing module 72 and the first communication module 73 and configured to transmit the location of the vehicle in the predetermined place to a mobile terminal when the vehicle stops. In addition, the acquired map of the predetermined place can also be sent to the mobile terminal together.

It will be appreciated that the first communication module 73 and the second communication module 74 may be integrated into a same communication module, and may be implemented as a vehicle-mounted radio terminal.

The present embodiment is based on the apparatus for positioning a vehicle that is discussed in preceding methods of positioning a vehicle, and share common implementation principles therewith and thus will not be detailed again.

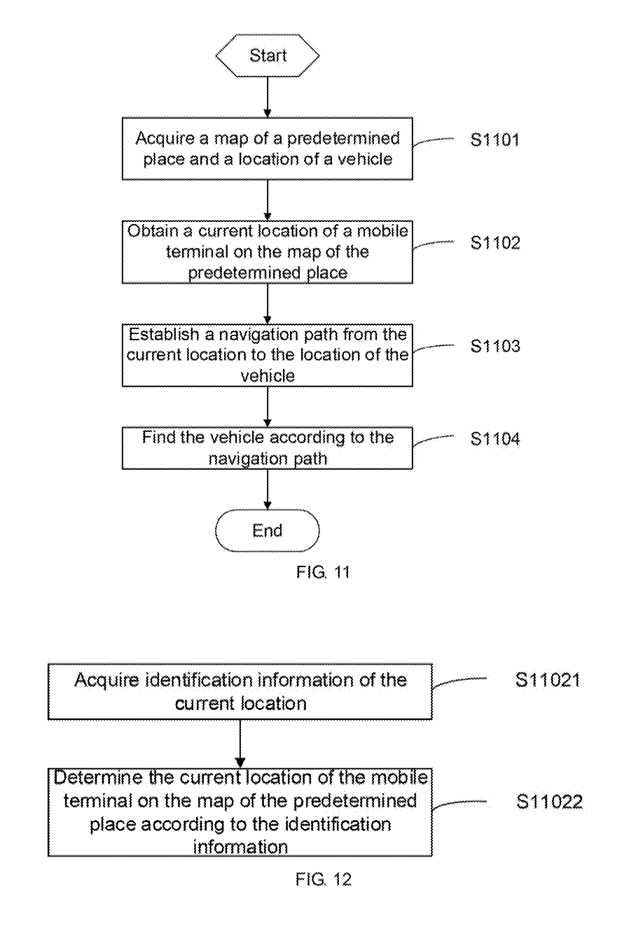

Referring now to FIG. 11, a flowchart illustrating an embodiment of a method of searching for a vehicle parked in a predetermined place according to the disclosure is depicted. For purposes of illustration, the method is illustrated as being sequential. However, portions of the method may be performed in other orders or in parallel (e.g., simultaneously). The method may comprise the following blocks.

At S1101, the method includes acquiring a map of the predetermined place and a location of the vehicle.

The location of the vehicle may be obtained using the method according to any one of the preceding embodiments. The map of the predetermined place may be obtained through the vehicle positioning apparatuses as discussed in the preceding embodiments, or be acquired by connecting to a LAN provided by the predetermined place.

At S1102, the method includes obtaining the current position of the mobile terminal on the map of the predetermined place.

If the predetermined place is a place where a GPS signal is difficult to reach or no GPS signal is available, then the current location of the mobile terminal may not be able to acquire through GPS positioning. In one embodiment, the mobile terminal user can enter the current location manually. For example, the user can perform a touch on an acquired offline map to indicate the terminal's current location.

Optionally, in one embodiment, as shown in FIG. 12, block S1102 may comprise the following steps.

In S11021, the method includes acquiring identification information of the current location.

Optionally, the identification information can be a two-dimensional code, barcode, or digital code containing information about the current location.

At S11022, the method includes determining the current location of the mobile terminal in the map of the predetermined place based on the identification information.

Specifically, while the mobile terminal obtains the map of the predetermined place, it can simultaneously acquire the corresponding identification information of different positions on the map. For example, each position on the predetermined place may be assigned a two-dimensional code that may be posted on the corresponding position of the predetermined place. The map of the predetermined place as acquired may comprise a plurality of representative positions together with their respective two-dimensional codes, so that the mobile terminal can scan a two-dimensional code and compare it with the previously acquired map of the predetermined place, to determine the current location of the mobile terminal (or user) on the map.

In S1103, the method includes establishing a navigation path from the current location to the location of the vehicle.

In S1104, the method includes searching for the vehicle according to the navigation path.

In particular, after acquiring the current location of the mobile terminal and the location of the vehicle, a navigation path can be established therebetween, according to which the user can find the vehicle.

Distinguished from the prior art, the vehicle searching method according to the present embodiment comprises: obtaining a map of the predetermined place and a location of the vehicle; acquiring a current location of the mobile terminal on the map of the predetermined place; establishing a navigation path from the current location to the location of the vehicle; and searching for the vehicle according to the navigation path. Thus, the vehicle previously parked in the predetermined place can be quickly and efficiently found in absence of GPS positioning or a GPS signal, thereby solving the issue that the vehicle cannot be found when the GPS signal is poor or no network connection is available.

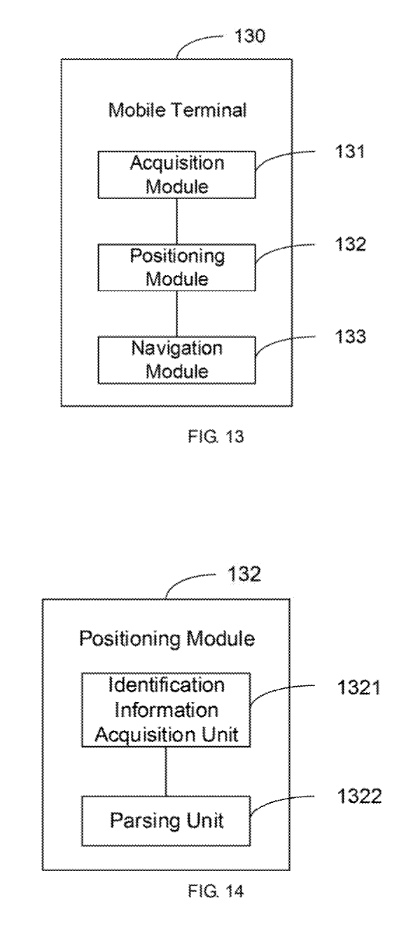

Referring now to FIG. 13, a block diagram illustrating a mobile terminal for searching for a vehicle parked in a predetermined place according to the disclosure is depicted. The mobile terminal 130 may comprise an acquisition module 131, a positioning module 132, and a navigation module 133.

The acquisition module 131 may be configured to acquire a map of the predetermined place and a location of the vehicle. The location of the vehicle may be obtained using the vehicle positioning apparatus according to any of the preceding embodiments.

The acquisition module 131 can be a communication module of the mobile terminal which acquires, through wireless Bluetooth or Wi-Fi or a wired connection such as a USB cable, the map of the predetermined place and location information of the vehicle that are transmitted from the vehicle-mounted positioning apparatus, so in this way the relevant information can be synchronized to the mobile terminal.

The positioning module 132 may be configured to obtain a current location of the mobile terminal on the map of the predetermined place.

Optionally, in one embodiment, as shown in FIG. 14, the positioning module 132 may comprise an identification information acquisition unit 1321, and a parsing unit 1322.

The identification information acquisition unit 1321 may be configured to obtain identification information of the current location.

Optionally, the identification information may be a two-dimensional code, and the identification information acquisition unit 1321 may be a two-dimensional code scanning unit, such as a camera equipped with the mobile terminal.

The parsing unit 1322 may be coupled to the identification information acquisition unit 1321 and configured to determine the current location of the mobile terminal on the map of the predetermined place according to the identification information.

The navigation module 133 may be coupled to the acquisition module 131 and the positioning module 132 respectively, and the navigation module 133 may be configured to establish a navigation path from the current location of the mobile terminal to the location of the vehicle, and thus, it is available to search for the vehicle according to the navigation path.

The present embodiment illustrates a mobile terminal based on the embodiment of the method of searching for the vehicle described above, and share common implementation principles therewith and thus will not be detailed again.

It can be appreciated that the disclosed methods, positioning apparatuses, and mobile terminals can also be implemented in other forms. Rather, the apparatuses and mobile terminals as described are merely illustrative. For example, the division of modules or units is based solely on logic functions, thus in actual implementations there may be other division methods-for instance, multiple units or modules may be combined or integrated onto another system, or some features may be ignored or simply not executed.

In addition, mutual couplings, direct couplings, or communication connections as displayed or discussed may be achieved through some interfaces, devices, or units, and may be achieved electrically, mechanically or in other forms.

Separated units as described may or may not be physically separated. Components displayed as units may or may not be physical units, and they may reside at one location or may be distributed to multiple networked units. Part or all of the units may be selectively adopted according to actual requirements to achieve objectives of the disclosure.

In addition, various functional units as discussed in the disclosure may be integrated into one processing unit, or may be presented as various physically separated units. Two or more units may be integrated into one. The integrated units may be implemented by hardware, or may be implemented as software functional units.

If the integrated units are implemented as software functional units and sold or used as standalone products, they can be stored in a computer readable storage medium. As such, all or part of technical solutions of the disclosure may be embodied as software products. Computer software products can be stored in a storage medium and can include multiple instructions enabling a computing device (e.g., a personal computer, server, network device, etc.) or a processor to execute all or part of the methods as described in various embodiments of the disclosure. The storage medium may include all kinds of media that can store program codes, such as a USB flash disk, mobile hard drive, Read-only Memory (ROM), Random Access Memory (RAM), magnetic disk, or optical disk.

Furthermore, it is apparent to those skilled in the art that, the present disclosure also provides a mobile terminal for positioning a location of a vehicle in a predetermined place, which comprises a non-transitory program storage and a processor. The non-transitory program storage medium stores a program executed by the processor to perform the methods as described above. Furthermore, it is apparent to those skilled in the art that, various units or modules 131, 132, 133, 1321, and 1322 as shown in FIG. 13 or 14 are software modules or software units. In another aspect, it is well-known that various software modules or software units are inherently stored in the non-transitory program storage medium and executed by the processor. The above description depicts merely some exemplary embodiments of the disclosure, but is meant to limit the scope of the disclosure. Any equivalent structure or flow transformations made to the disclosure, or any direct or indirect applications of the disclosure on other related fields, shall all be covered within the protection of the disclosure.

1. A method of positioning a location of a vehicle in a predetermined place, comprising:
collecting surrounding environmental information of the vehicle via configuring a collecting device by at least one way of laser, camera, infrared detection, acoustic detection; wherein the surrounding environmental information comprises at least one of those information about roads, walls, columns, barrier gates, fences, graphics of signages, fire-fighting equipment and lighting equipment; and
determining the location of the vehicle in the predetermined place by comparing the surrounding environmental information with a previously acquired map of the predetermined place by a processor, and wherein the processor is coupled to the collecting device; wherein the previously acquired map of the predetermined place comprises at least one of those information about roads, walls, columns, barrier gates, fences, graphics of signages, fire-fighting equipment and lighting equipment;
wherein, there is no available GPS signal at the predetermined place.

2. The method according to claim 1, wherein the step of collecting the surrounding environmental information of the vehicle comprises:
emitting, by the vehicle, laser light in a predetermined direction; and
receiving, by the vehicle, a reflected light signal by an obstacle reflecting the laser light.

3. (canceled)

4. The method according to claim 2, wherein the step of determining the location of the vehicle by comparing the surrounding environmental information with the map of the predetermined place comprises:
analyzing the reflected light signal to obtain a driving route of the vehicle in the predetermined place; and
determining the location of the vehicle in the predetermined place by comparing the driving route with the map of the predetermined place.

5. The method according to claim 4, wherein the step of analyzing the reflected light signal to obtain the driving route of the vehicle comprises:
calculating a distance between the vehicle and the obstacle based on a time interval from emitting the laser light to receiving the reflected light signal; and
computing and determining the driving route based on the distance, depth information and shapes of obstacles along the driving route.

6. The method according to claim 5, wherein Simultaneous Localization and Mapping (SLAM) positioning technology is applied to continuously collect the types of the obstacles along the determined driving route, and the distances between the vehicle and the obstacles along the determined the driving route.

7. The method according to claim 2, wherein the step of determining the location of the vehicle by comparing the surrounding environmental information with the map of the predetermined place comprises:
analyzing the reflected light signal to obtain the surrounding environmental information of the vehicle; and
determining the location of the vehicle in the predetermined place by comparing the surrounding environmental information with the map of the predetermined place.

8. The method according to claim 7, wherein Simultaneous Localization and Mapping (SLAM) positioning technology is applied to continuously collect the types of the obstacles along the determined driving route and distances between the vehicle and the obstacles along the determined the driving route to obtain the surrounding information of the vehicle.

9. The method according to claim 1, further comprising:
using a binocular vision algorithm to obtain the surrounding environmental information of the vehicle.

10. A method of searching for a vehicle parked in a predetermined place, the method performed by a mobile terminal and comprising:
using the positioning method of claim 1 to obtain the location of the vehicle after parking, and transmitting the location of the vehicle to the mobile terminal;
acquiring a map of the predetermined place;
obtaining a current location of the mobile terminal on the map of the predetermined place;
establishing a navigation path from the current location to the location of the vehicle; and
searching for the vehicle according to the navigation path.

11. The method according to claim 10, wherein the block of acquiring the current location of the mobile terminal on the map of the predetermined place comprises:
acquiring identification information of the current location of the mobile terminal; and
determining the current location of the mobile terminal on the map of the predetermined place based on the identification information.

12. The method according to claim 11, wherein the identification information is a two-dimensional code.

13. An apparatus for positioning a location of a vehicle in a predetermined place, comprising:
a collecting device configured to collect surrounding environmental information of the vehicle by at least one way of laser, camera, infrared detection, acoustic detection;
wherein the surrounding environmental information comprises at least one of those information about roads, walls, columns, barrier gates, fences, graphics of signages, fire-fighting equipment and lighting equipment; and
a processor coupled to the collecting device and configured to determine the location of the vehicle in the predetermined place by comparing the surrounding environmental information with a previously acquired map of the predetermined place; wherein the previously acquired map of the predetermined place comprises at least one of those information about roads, walls, columns, barrier gates, fences, graphics of signages, fire-fighting equipment and lighting equipment;
wherein, there is no available GPS signal at the predetermined place.

14. The apparatus according to claim 13, wherein the collecting device comprises:
at least one of laser emitter each configured to emit laser light in a predetermined direction; and
at least one of laser receiver each configured to receive a reflected light signal by an obstacle reflecting the laser light.

15. (canceled)

16. The apparatus according to claim 14, wherein the processor is configured to:
analyze the reflected light signal to obtain a driving route of the vehicle in the predetermined place; and
determine the location of the vehicle in the predetermined place by comparing the driving route with the map of the predetermined place.

17. The apparatus according to claim 14, wherein the processor is configured to:
analyze the reflected light signal to obtain the surrounding environmental information of the vehicle; and
determine the location of the vehicle in the predetermined place by comparing the surrounding environmental information of the vehicle with the map of the predetermined place.

18. The apparatus according to claim 13, wherein the collecting device comprises a visual sensor configured to use a binocular vision algorithm to collect the surrounding environmental information of the vehicle.

19. A mobile terminal for searching for a vehicle parked in a predetermined place, comprising a non-transitory program storage medium and a processor, the non-transitory program storage medium comprising:
an acquisition module configured to obtain a map of the predetermined place and a location of the vehicle in the predetermined place, wherein the location of the vehicle is obtained from the vehicle by the positioning apparatus according to claim 13;
a positioning module configured to obtain a current location of the mobile terminal on the map of the predetermined place; and
a navigation module coupled to the acquisition module and the positioning module and configured to establish a navigation path from the current location to the location of the vehicle and so find the vehicle according to the navigation path.

20. The mobile terminal according to claim 19, wherein the positioning module comprises:
an identification information acquisition unit, configured to obtain identification information of the current location; and
a parsing unit, coupled to the identification information acquisition unit, and configured to determine the current location of the mobile terminal on the map of the predetermined place according to the identification information.
